(19) United States
(12) Patent Application Publication
(10) Pub. No.: US 2021/0339513 A1
(43) Pub. Date: Nov. 4, 2021

(54) GAS BARRIER LAMINATE

(71) Applicant: National Taipei University of Technology, Taipei City (TW)

(72) Inventors: Chung-Kuan YANG, Taipei City (TW); Kun-Li WANG, Taipei City (TW); Sheng-Tung HUANG, Taipei City (TW); Ting-Yu CHEN, Taipei City (TW)

(21) Appl. No.: 16/936,104

(22) Filed: Jul. 22, 2020

(30) Foreign Application Priority Data
May 4, 2020 (TW) 109114773

(51) Int. Cl. B32B 27/14; B32B 27/36; B32B 27/28

(52) U.S. Cl. CPC B32B 27/14; B32B 2457/206; B32B 27/283; B32B 2250/05; B32B 2255/10; B32B 2255/20; B32B 2255/24; B32B 2255/28; B32B 2264/1021; B32B 2264/1023; B32B 2307/7244; B32B 2307/7246; B32B 2307/412; B32B 2307/546; B32B 2310/14; B32B 2367/00; B32B 2383/00; B32B 27/36

(57) ABSTRACT

A gas barrier laminate includes an organic layer and an inorganic layered unit. The organic layer includes a product obtained by subjecting a silane compound having an alkoxy group to hydrolysis and condensation. The inorganic layered unit is disposed on the organic layer, and includes an aluminum oxide layer, a hafnium oxide layer, and a silicon aluminum oxide layer that are laminated to one another.

### CROSS-REFERENCE TO RELATED APPLICATION

This application claims priority of Taiwanese Invention Patent Application No. 109114773, filed on May 4, 2020.

### FIELD

The disclosure relates to a laminate, and more particularly to a gas barrier laminate.

### BACKGROUND

With the rapid development of electronic products, thick transparent glass substrates are gradually being replaced by transparent plastic substrates which are light, thin, and flexible, and which have high plasticity. Nowadays, technologies related to flexible electronic devices, such as electronic papers, dye-sensitized solar cells (DSSCs), organic photovoltaics (OPVs), organic light-emitting diodes (OLEDs), and the like, have become the top development trends.

However, certain components of these flexible electronic devices, such as OPVs or OLEDs, contain therein, organic materials that are highly sensitive and cathode metals that are prone to oxidation. The transparent plastic substrate has a disadvantage of high oxygen and water vapor transmission rates, which easily causes water vapor and oxygen in the air to penetrate through the transparent plastic substrate into the interior of the flexible electronic devices, resulting in deterioration and aging of the organic light-emitting materials and the metal electrodes within the flexible electronic devices, thereby reducing the stability and the lifespan of the flexible electronic devices.

Therefore, in order to extend the lifespan of flexible electronic devices, those in the industry usually use a barrier film having water vapor and oxygen barrier functions to block water vapor and oxygen from penetrating into the components of the flexible electronic devices, thereby preventing deterioration and/or aging of the organic materials and the cathode metals within the components. In addition, a water vapor barrier film is required to have good light transmission property and the like for commercial applications.

### SUMMARY

Therefore, an object of the disclosure is to provide a gas barrier laminate having good water vapor-blocking and oxygen-blocking capabilities and good optical properties.

According to the disclosure, there is provided a gas barrier laminate, which includes an organic layer and an inorganic layered unit. The organic layer includes a product obtained by subjecting a silane compound having an alkoxy group to hydrolysis and condensation. The inorganic layered unit is disposed on the organic layer, and includes an aluminum oxide layer, a hafnium oxide layer, and a silicon aluminum oxide layer that are laminated to one another.

### BRIEF DESCRIPTION OF THE DRAWINGS

Other features and advantages of the disclosure will become apparent in the following detailed description of the embodiments with reference to the accompanying drawings, of which:

FIG. 1 is a schematic side view of a first embodiment of a gas barrier laminate according to the disclosure;

FIG. 2 is a schematic side view of a second embodiment of the gas barrier laminate according to the disclosure;

FIG. 3 is a schematic side view of a third embodiment of the gas barrier laminate according to the disclosure;

FIG. 4 is a schematic side view of a fourth embodiment of the gas barrier laminate according to the disclosure;

FIG. 5 is a schematic side view of a fifth embodiment of the gas barrier laminate according to the disclosure;

FIG. 6 is a schematic side view of a sixth embodiment of the gas barrier laminate according to the disclosure;

FIG. 7 is a schematic side view of a seventh embodiment of the gas barrier laminate according to the disclosure; and

FIG. 8 depicts a graph plot of light transmittance versus wavelength for the gas barrier laminates of Examples 1 to 6.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

The term “gas” as used herein includes, but is not limited to, water vapor, oxygen, and other gases.

A gas barrier laminate according to the disclosure includes a light-transmissible substrate, an organic layer disposed on the light-transmissible substrate, and an inorganic layered unit disposed on the organic layer.

The light-transmissible substrate may be, for example, but not limited to, a flexible substrate having visible light transmission. There is no limitation to the material for making the light-transmissible substrate, and examples of the material for making the light-transmissible substrate may include, but are not limited to, polyester resin, polyacrylate resin, polyolefin resin, polycarbonate resin, polyvinyl chloride, polyimide resin, and polylactic acid. Examples of the polyester resin may include, but are not limited to, polyethylene terephthalate (PET) and polyethylene naphthalate (PEN) A non-limiting example of the polyacrylate resin is polymethyl methacrylate (PMMA). Examples of the polyolefin resin may include, but are not limited to, polyethylene and polypropylene. The light-transmissible substrate may be optionally surface-modified by, for example, but not limited to, an oxygen plasma treatment. There is no limitation to a thickness of the light-transmissible substrate. The thickness of the light-transmissible substrate may range, for example, from 25 μm to 250 μm.

The organic layer includes a product obtained by subjecting a silane compound having an alkoxy group to hydrolysis and condensation. Examples of the silane compound may include, but are not limited to, tetraethoxysilane (TEOS), phenyltriethoxysilane (PTES), trimethoxypropylsilane, 3-glycidoxypropyltrimethoxysilane (GPTMS), (3-aminopropyl)triethoxysilane (APTES), 3-mercaptopropyltrimethoxysilane, vinyltrimethoxysilane (VTMS), vinyltriethoxysilane (VTES), 1,3-divinyltetramethyldisiloxane, triethoxypropylsilane, dimethoxydicyclopentylsilane, diphenyldimethoxysilane, and combinations thereof. There is no limitation to the reaction conditions for hydrolysis and condensation. For example, the reaction conditions for a sol-gel process well-known in the art may be modified flexibly so as to be useable as the reaction conditions for hydrolysis and condensation. As an example, a silane compound having an alkoxy group and water may be subjected to hydrolysis and condensation in an acidic environment. In certain embodiments, the organic layer has a thickness ranging, for example, from 500 nm to 2000 nm, but is not limited thereto.

The inorganic layered unit is disposed on the organic layer, and includes an aluminum oxide layer, a hafnium oxide layer, and a silicon aluminum oxide layer that are laminated to one another.

The aluminum oxide layer may be prepared by, for example, but not limited to, sputtering from an aluminum oxide target. The sputtering may be implemented by, for example, but not limited to, direct current (DC) magnetron sputtering or radio-frequency (RF) magnetron sputtering at a sputtering power ranging from 30 W to 120 W and an argon flow ranging from 5 sccm to 50 sccm. In certain embodiments, the aluminum oxide layer has a thickness ranging, for example, from 10 nm to 200 nm, but is not limited thereto.

The hafnium oxide layer may be prepared by, for example, but not limited to, sputtering from a hafnium oxide target. The sputtering may be implemented by, for example, but not limited to, DC magnetron sputtering or RF magnetron sputtering at a sputtering power ranging from 30 W to 100 W, an oxygen flow ranging from 2 sccm to 20 sccm, and an argon flow ranging from 5 sccm to 50 sccm. In certain embodiments, the hafnium oxide layer has a thickness ranging, for example, from 10 nm to 50 nm, but is not limited thereto.

The silicon aluminum oxide layer may be prepared by, for example, but not limited to, sputtering from a silicon aluminum oxide target in an oxygen atmosphere. An atomic ratio of silicon to aluminum in the silicon aluminum oxide target ranges from 10:90 to 90:10. The sputtering may be implemented by, for example, but not limited to, DC magnetron sputtering or RF magnetron sputtering at a sputtering power ranging from 30 W to 100 W, an oxygen flow ranging from 2 sccm to 10 sccm, and an argon flow ranging from 5 sccm to 50 sccm. In certain embodiments, the silicon aluminum oxide layer has a thickness ranging, for example, from 10 nm to 100 nm, but is not limited thereto. In certain embodiments, in the silicon aluminum oxide layer, oxygen is present in an amount ranging from 59 at % (atom %) to 62 at %, aluminum is present in an amount ranging from 5 at % to 17 at %, and silicon is present in an amount ranging from 23 at % to 33 at % based on 100 at % of the silicon aluminum oxide layer. In certain embodiments, in the silicon aluminum oxide layer, an atomic ratio of silicon to aluminum ranges from 1.42:1 to 6.46:1, and in certain embodiments, in the silicon aluminum oxide layer, the atomic ratio of silicon to aluminum is 2.75:1, such that the gas barrier laminate may have superior water vapor-blocking and oxygen-blocking capabilities and good optical properties.

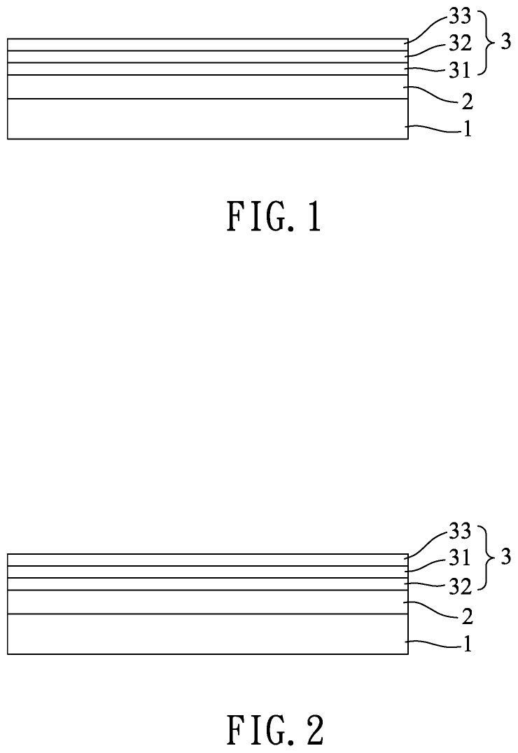

Referring to FIG. 1, in a first embodiment of a gas barrier laminate according to the disclosure, the organic layer 2 is disposed on the light-transmissible substrate 1, and the inorganic layered unit 3 is disposed on the organic layer 2. The inorganic layered unit 3 includes the aluminum oxide layer 31, the hafnium oxide layer 32, and the silicon aluminum oxide layer 33 that are laminated to one another. Specifically, the aluminum oxide layer 31 and the hafnium oxide layer 32 are disposed between the silicon aluminum oxide layer 33 and the organic layer 2. The aluminum oxide layer 31 is disposed on the organic layer 2. The hafnium oxide layer 32 is disposed between the aluminum oxide layer 31 and the silicon aluminum oxide layer 33.

Referring to FIG. 2, a second embodiment of the gas barrier laminate according to the disclosure has a configuration similar to that of the first embodiment, except that in the second embodiment, the hafnium oxide layer 32 is disposed on the organic layer 2, and the aluminum oxide layer 31 is disposed between the hafnium oxide layer 32 and the silicon aluminum oxide layer 33.

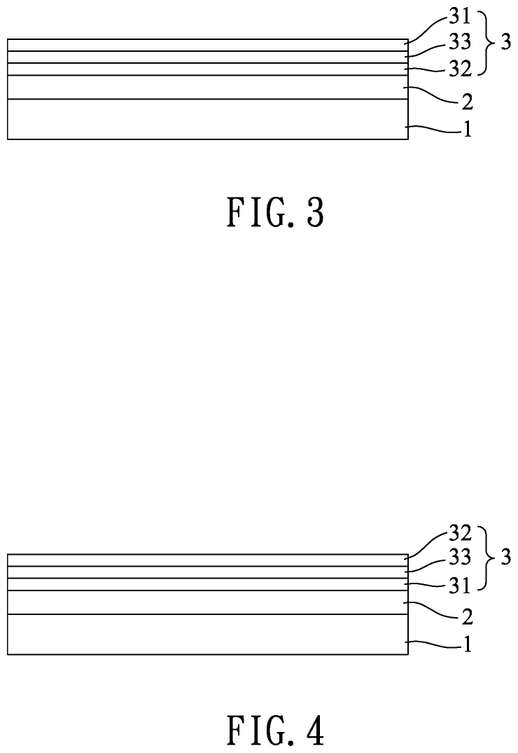

Referring to FIG. 3, a third embodiment of the gas barrier laminate according to the disclosure has a configuration similar to that of the first embodiment, except that in the third embodiment, the silicon aluminum oxide layer 33 is disposed between the aluminum oxide layer 31 and the hafnium oxide layer 32, and the hafnium oxide layer 32 is disposed on the organic layer 2.

Referring to FIG. 4, a fourth embodiment of the gas barrier laminate according to the disclosure has a configuration similar to that of the first embodiment, except that in the fourth embodiment, the silicon aluminum oxide layer 33 is disposed between the aluminum oxide layer 31 and the hafnium oxide layer 32, and the aluminum oxide layer 31 is disposed on the organic layer 2.

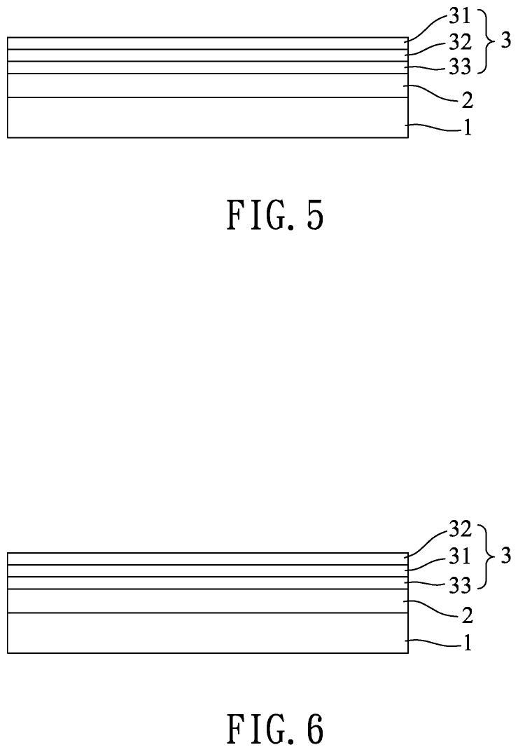

Referring to FIG. 5, a fifth embodiment of the gas barrier laminate according to the disclosure has a configuration similar to that of the first embodiment, except that in the fifth embodiment, the silicon aluminum oxide layer 33 is disposed on the organic layer 2, and the hafnium oxide layer 32 is disposed between the silicon aluminum oxide layer 33 and the aluminum oxide layer 31.

Referring to FIG. 6, a sixth embodiment of the gas barrier laminate according to the disclosure has a configuration similar to that of the first embodiment, except that in the sixth embodiment, the silicon aluminum oxide layer 33 is disposed on the organic layer 2, and the aluminum oxide layer 31 is disposed between the silicon aluminum oxide layer 33 and the hafnium oxide layer 32.

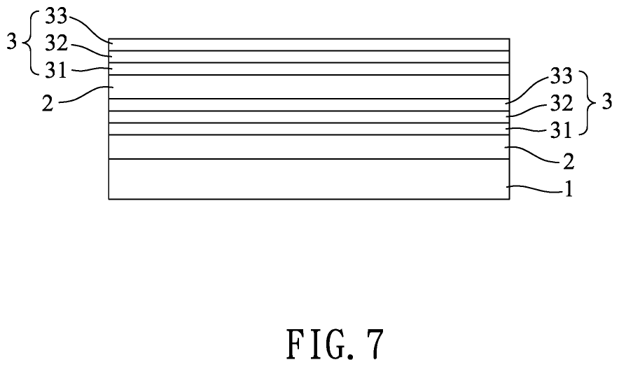

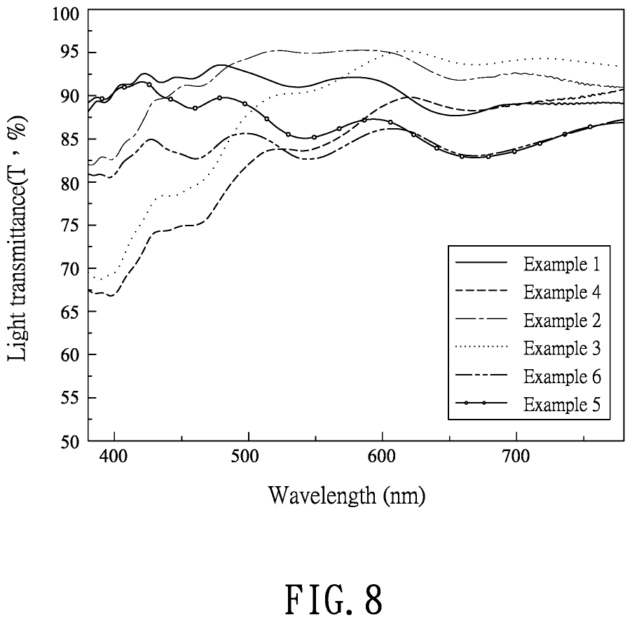

Referring to FIG. 7, a seventh embodiment of the gas barrier laminate according to the disclosure has a configuration similar to that of the first embodiment, except that in the seventh embodiment, the gas barrier laminate includes two organic layers 2 and two inorganic layered units 3 that are laminated to one another.

It should be understood that when the gas barrier laminate includes a plurality of the organic layers 2 and a plurality of the inorganic layered units 3, the numbers of the organic layers 2 and the inorganic layered units 3 may be two or more, and each of the inorganic layered units 3 may independently have a laminated configuration of any of those in the first to seventh embodiments.

Examples of the disclosure will be described hereinafter. It is to be understood that these examples are exemplary and explanatory and should not be construed as a limitation to the disclosure.

### Example 1: Manufacturing a Gas Barrier Laminate

The gas barrier laminate of Example 1 has a configuration of the first embodiment as described above. The organic layer, the aluminum oxide layer, the hafnium oxide layer, and the silicon aluminum oxide layer of the gas barrier laminate were prepared as below.

### Preparation of the Organic Layer (Thickness: 800 nm):

Tetraethoxysilane (commercially available from Aldrich Chemical Co., purity: 98%, referred to as TEOS hereinafter) and phenyltriethoxysilane (commercially available from Aldrich Chemical Co., purity: 98%, referred to as PTES hereinafter) were mixed under stirring at a molar ratio of TEOS to PTES of 1:2.33 to obtain a first composition. Deionized water, ethanol (as a cosolvent, commercially available from Fisher, purity: 99.8%), and hydrochloric acid (concentration: 36.5%) were mixed homogeneously under stirring at a weight ratio of deionized water to ethanol to hydrochloric acid of 380:60:1 to obtain a second composition. The second composition was added dropwise to the first composition to obtain a third composition. The third composition was stirred continuously until the temperature thereof reached a room temperature (25° C.), followed by continuous stirring for 24 hours to complete reaction of the third composition, so as to obtain a product. The product was mixed with n-butanol (as a solvent) under stirring for 30 minutes, followed by filtration using a filter paper having a pore size of 0.22 μm to obtain a mixture solution having a solid content of 20%.

A light-transmissible polyethylene terephthalate (PET) substrate (Manufacturer: Nan-Ya plastics corp., Taiwan, Model No.: CH885Y, thickness: 125 μm) was washed using supersonic vibration in an ethanol solution (ethanol concentration: 75%) for 5 minutes, and was further washed using supersonic vibration in acetone for 5 minutes. Thereafter, the light-transmissible PET substrate was baked in an oven at 80° C. for 5 minutes, followed by cleaning using pressurized air. The mixture solution was then applied evenly on the light-transmissible PET substrate using a roll-to-roll coating machine (Manufacturer: THANK METAL CO. LTD., Model No.: CH25083G) at a coating speed of 0.5 M/min to form a coating layer on the light-transmissible PET substrate. The light-transmissible PET substrate with the coating layer was baked in an oven at a temperature of 80° C. for a time period of 1.6 minutes, then at a temperature of 120° C. for a time period of 1.6 minutes, and finally at a temperature of 80° C. for a time period of 1.6 minutes to cure the coating layer, so as to obtain a first laminate including the light-transmissible PET substrate and an organic layer formed on the substrate.

### Preparation of the Inorganic Layered Unit:

The aluminum oxide layer, the hafnium oxide layer, and the silicon aluminum oxide layer were formed sequentially on the organic layer of the first laminate using an RF magnetron sputtering equipment (Manufacturer: Kao Duen Technology Corp., Taiwan, Model. No.: R-24K08-SPUTTERING). The sputtering conditions for forming the aluminum oxide layer, the hafnium oxide layer, and the silicon aluminum oxide layer are described in details below.

Sputtering Conditions for Forming the Aluminum Oxide Layer (Thickness: 60 nm):

Target: an aluminum oxide target (commercially available from We Jump Material Technology Co., Ltd., Taiwan, purity: 99.99%, diameter: 2 inches),

Background pressure: 5×10⁻⁶ torr,

Working pressure: 2 mtorr,

Rotation speed of a carrier: 20 rpm,

Argon flow: 30 sccm,

Sputtering power: 100 W, and

Sputtering time period: 72 minutes.

Sputtering Conditions for Forming the Hafnium Oxide Layer (Thickness: 50 nm):

Target: a hafnium oxide target (commercially available from We Jump Material Technology Co., Ltd., Taiwan, purity: 99.99%, diameter: 2 inches),

Background pressure: 5×10⁻⁶ torr,

Working pressure: 2 mtorr,

Rotation speed of a carrier: 20 rpm,

Argon flow: 30 sccm,

Oxygen flow: 8 sccm,

Sputtering power: 100 W, and

Sputtering time period: 80 minutes.

Sputtering Conditions for Forming the Silicon Aluminum Oxide Layer (Thickness: 60 nm):

Target: a silicon aluminum target (commercially available from We Jump Material Technology Co., Ltd., Taiwan, purity: 99.999%, a weight ratio of silicon to aluminum: 70:30, diameter: 2 inches),

Background pressure: 5×10⁻⁶ torr,

Working pressure: 2 mtorr,

Rotation speed of a carrier: 20 rpm,

Argon flow: 30 sccm,

Oxygen flow: 4 sccm,

Sputtering power: 80 W, and

Sputtering time period: 25 minutes.

The silicon aluminum oxide layer was analyzed using an X-ray photoelectron spectrometer (XPS, Manufacturer: Jeol Ltd., Japan; Model No.: JSP-9030). It was determined that in the silicon aluminum oxide layer, oxygen was present in an amount of 61.10 at %, aluminum was present in an amount of 10.38 at %, silicon was present in an amount of 28.52 at %, and an atomic ratio of silicon to aluminum was 2.75:1.

### Examples 2 to 7: Manufacturing Gas Barrier Laminates

The gas barrier laminates of Examples 2 to 7 were made by procedures similar to those of Example 1, except that the laminate configurations thereof were changed as shown in Table 1, in which the gas barrier laminate of Example 2 had a laminate configuration similar to that of the second embodiment, the gas barrier laminate of Example 3 had a laminate configuration similar to that of the third embodiment, the gas barrier laminate of Example 4 had a laminate configuration similar to that of the fourth embodiment, the gas barrier laminate of Example 5 had a laminate configuration similar to that of the fifth embodiment, the gas barrier laminate of Example 6 had a laminate configuration similar to that of the sixth embodiment, and the gas barrier laminate of Example 7 had a laminate configuration similar to that of the seventh embodiment.

### Property Evaluations:

### 1. Average Light Transmittance:

An UV-VIS spectrophotometer (Model No.: Agilent Cary 5000) was subjected to an all-optical calibration using air as a background. Light transmittance values (T %) at a wavelength ranging from 380 nm to 780 nm of the gas barrier laminate of each of Examples 1 to 7 were then measured using the UV-VIS spectrophotometer, and an average light transmittance of the gas barrier laminate of each of Examples 1 to 7 was calculated from the measured light transmittance values. The results are shown in Table 1 below.

### 2. Color Value:

Color value of the gas barrier laminate of each of Examples 1 to 7 was measured according to CIE LAB color space using the UV-VIS spectrophotometer (Model No.: Agilent Cary 5000) together with a color grading software (Color). A positive a* value indicates redness, and a negative a* value indicates greenness. An absolute value of the a* value in a range from 0 to 1 indicates the color is not visible to the human eye. A positive b* value indicates yellowness, and a negative b* value indicates blueness. An absolute value of the b* value in a range from 0 to 1 indicates the color is not visible to the human eye. The results are shown in Table 1 below.

### 3. Water Vapor Transmission Rate (WVTR):

The water vapor transmission rate of the gas barrier laminate of each of Examples 1 to 7 was measured using a water vapor permeation instrument (Manufacturer: Ametek Mocon; Model No.: Mocon AQUATRAN® Model 2 G, detection limit: 5×10⁻⁵ g/m²·day). The gas barrier laminate to be measured was mounted in a sample holder of the water vapor permeation instrument. The sample holder was maintained at a temperature of 37.8° C. One side of the sample holder was controlled to have a relative humidity of 100% using a humidity meter equipped in the water vapor permeation instrument and was charged with nitrogen gas at a flow of 20 sccm. Water vapor carried by the nitrogen gas transmitted from the one side of the sample holder through the gas barrier laminate, and then entered into a P₂O₅ (phosphorous pentaoxide) sensor equipped at the other side of the sample holder to detect an amount of water vapor permeating through the gas barrier laminate, thereby analyzing the water vapor transmittance rate of the gas barrier laminate. The lower the water vapor transmission rate, the better the water vapor-blocking capability of the gas barrier laminate. The results are shown in Table 1 below.

### 4. Oxygen Transmission Rate (OTR):

Oxygen transmission rate of the gas barrier laminate of each of Examples 1 to 7 was measured using an oxygen permeation instrument (Manufacturer: Ametek Mocon; Model No.: Mocon OX-TRAN Model 2/61, detection limit: 0.5 cc/m²·day). The gas barrier laminate to be measured was mounted in a sample holder of the oxygen permeation instrument. The sample holder was maintained at a temperature of 23° C. One side of the sample holder was controlled to have a relative humidity of 0% and was charged with nitrogen gas at a flow of 10 sccm. Oxygen (concentration: 100%) carried by the nitrogen gas transmitted from the one side of the sample holder through the gas barrier laminate, and then entered into a coulombic sensor equipped at the other side of the sample holder to detect an amount of oxygen permeating through the gas barrier laminate, thereby analyzing the oxygen transmittance rate of the gas barrier laminate. The lower the oxygen transmission rate, the better the oxygen-blocking capability of the gas barrier laminate. The results are shown in Table 1 below.

TABLE 1

| | | | Average light | | | | | |
|---|---|---|---|---|---|---|---|---|
| | | | transmittance | CIE LAB | | | WVTR | OTR |
| | | Laminates | (%) | L | a* | b* | (g/m² · day) | (cc/m² · day) |
| Examples | 1 | POAHS | 91.53 | 96.6147 | −0.6317 | −0.8084 | 0.03364 | <0.5 |
| | 2 | POHAS | 91.98 | 97.9464 | 0.6157 | 0.3832 | 0.06684 | <0.5 |
| | 3 | POHSA | 88.43 | 96.5176 | −0.6532 | 2.7272 | 0.06062 | <0.5 |
| | 4 | POASH | 83.45 | 93.8846 | 0.034 | 7.2964 | 0.04126 | <0.5 |
| | 5 | POSHA | 86.76 | 94.4811 | 0.5925 | −2.2271 | 0.1101 | 3.7526 |
| | 6 | POSAH | 84.26 | 93.5646 | −0.9219 | 8.3462 | 0.09034 | 1.3362 |
| | 7 | POAHSOAHS | 88.08 | 95.2804 | 0.6915 | 0.1484 | <5 × 10⁻⁵ | <0.5 |

Note:
P indicates a light-transmissible PET substrate having a thickness of 125 μm;
O indicates an organic layer having a thickness of 800 nm;
H indicates a hafnium oxide layer having a thickness of 50 nm;
S indicates a silicon aluminum oxide layer having a thickness of 60 nm; and an atomic ratio of silicon to aluminum thereof is 2.75:1; and
A indicates an aluminum oxide layer having a thickness of 60 nm.

As shown in Table 1, the gas barrier laminates of Examples 1 to 7 have good water vapor-blocking and oxygen-blocking capabilities and high light transmittance. Specifically, the gas barrier laminate of each of Examples 1 to 4 has a low water vapor transmission rate in an order of 10⁻², an oxygen transmission rate lower than the detection limit of the oxygen permeation instrument, and a light transmittance of greater than 83%. More specifically, the gas barrier laminate of each of Examples 1 and 2 has a low water vapor transmission rate in an order of 10⁻², an oxygen transmission rate lower than the detection limit of the oxygen permeation instrument, and a light transmittance of greater than 91%. In addition, the gas barrier laminate of each of Examples 1 and 2 has absolute values of the a* and b* values of less than 1, indicating that the gas barrier laminate of each of Examples 1 and 2 is substantially transparent and colorless to the human eye.

In view of the aforesaid, in the gas barrier laminate according to the disclosure, the organic layer cooperates with the inorganic layered unit which includes the aluminum oxide layer, the hafnium oxide layer, and the silicon aluminum oxide layer, so as to provide the gas barrier laminate with good water vapor-blocking and oxygen-blocking capabilities and good optical properties.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A gas barrier laminate, comprising:
an organic layer including a product obtained by subjecting a silane compound having an alkoxy group to hydrolysis and condensation; and
an inorganic layered unit which is disposed on said organic layer, and which includes an aluminum oxide layer, a hafnium oxide layer, and a silicon aluminum oxide layer that are laminated to one another.

2. The gas barrier laminate according to claim 1, wherein in said silicon aluminum oxide layer, an atomic ratio of silicon to aluminum ranges from 1.42:1 to 6.46:1.

3. The gas barrier laminate according to claim 2, wherein in said silicon aluminum oxide layer, said atomic ratio of silicon to aluminum is 2.75:1.

4. The gas barrier laminate according to claim 1, wherein said hafnium oxide layer and said aluminum oxide layer are disposed between said silicon aluminum oxide layer and said organic layer.

5. The gas barrier laminate according to claim 4, wherein said aluminum oxide layer is disposed on said organic layer, and said hafnium oxide layer is disposed between said aluminum oxide layer and said silicon aluminum oxide layer.

6. The gas barrier laminate according to claim 4, wherein said hafnium oxide layer is disposed on said organic layer, and said aluminum oxide layer is disposed between said hafnium oxide layer and said silicon aluminum oxide layer.

7. The gas barrier laminate according to claim 1, wherein said silicon aluminum oxide layer is disposed between said aluminum oxide layer and said hafnium oxide layer.

8. The gas barrier laminate according to claim 7, wherein said hafnium oxide layer is disposed on said organic layer.

9. The gas barrier laminate according to claim 7, wherein said aluminum oxide layer is disposed on said organic layer.

10. The gas barrier laminate according to claim 1, wherein said silicon aluminum oxide layer is disposed on said organic layer.
